(19) United States
(12) Patent Application Publication
(10) Pub. No.: US 2007/0173210 A1
(43) Pub. Date: Jul. 26, 2007

(54) Signal processing apparatus

(75) Inventor: Jeong Hoon Cho, Gyeonggi-do (KR)

Correspondence Address: BIRCH STEWART KOLASCH & BIRCH, PO BOX 747, FALLS CHURCH, VA, 22040-0747, US

(73) Assignee: LG INNOTEK CO., LTD

(21) Appl. No.: 11/657,603

(22) Filed: Jan. 25, 2007

(30) Foreign Application Priority Data
Jan. 26, 2006 (KR) 10-2006-0008515
May 4, 2006 (KR) 10-2006-0040598

(51) Int. Cl. H04B 1/44

(52) U.S. Cl. 455/78

(57) ABSTRACT

Provided is a signal processing apparatus. The apparatus comprises a first signal separating unit and a second signal separating unit. The first signal separating unit receives first reception signals via an antenna, allows first transmission signals to be transmitted via the antenna, and blocks second reception signals. The second signal separating unit receives second reception signals via the antenna, allows second transmission signals to be transmitted via the antenna, and blocks first reception signals.

### BACKGROUND OF THE INVENTION

1. Field of the Invention

The present invention relates to a signal processing apparatus.

2. Description of the Related Art

Recently, a mobile communication system tends to have a more complicated function to satisfy various demands of consumers.

Meanwhile, a mobile communication terminal has a limitation that it should be conveniently carried by a consumer through simplification and miniaturization of parts. Therefore, recently, a dual band terminal has emerged to provide a diplexer for receiving signals in two different frequency bands via a single antenna simultaneously and separating the received signals, and to process signals in two different frequency bands together.

Generally, a dual band mobile communication terminal includes a diplexer capable of receiving signals in different frequency bands, for example, signals in a code division multiple access (CDMA) frequency band (824-894 MHz) and signals in a personal communication service (PCS) frequency band (1.85-1.99 GHz) via a single input terminal, and separating the received signals into two output terminals.

Also, the dual band mobile communication terminal can separate signals in other frequency band using a switching device such as a single pole double throw instead of providing a diplexer.

FIG. 1 is a schematic block diagram illustrating elements of a dual band mobile communication terminal according to a related art.

Referring to FIG. 1, a PCS/digital cellular network (DCN) transceiver 10 of the dual band mobile communication terminal according to the related art includes a diplexer 11, a DCN duplexer 12, a PCS duplexer 13, a DCN signal processor 14, and a PCS signal processor 15.

Here, though not shown, a global positioning system (GPS) receiver for processing GPS signals can be separately provided. The GPS receiver includes a GPS receiving antenna, a GPS surface acoustic wave (SAW) filter, a GPS low noise amplifier (LNA), and a GPS signal processor.

The diplexer 11 separates signals in two frequency bands received via the dual band antenna, and delivers the separated signals to the DCN duplexer 12 or the PCS duplexer 13.

Generally, the diplexer 11 can be a stacked chip-type diplexer. The stacked chip-type diplexer is formed by stacking a plurality of dielectric substrates. The dielectric substrates are formed by stacking conductive patterns of high pass filters and low pass filters. The diplexer 11 separates signals received via a single antenna into signals in respective frequency bands, and provides the separated signals to the signal processors for the respective frequency bands arranged in a rear end.

Each of the DCN duplexer 12 and the PCS duplexer 13 has a high pass filter and a low pass filter. The DCN duplexer 12 delivers DCN reception signals from the diplexer 11 to the DCN signal processor 14, and the PCS duplexer 13 delivers PCS reception signals to the PCS signal processor 15 to reproduce the delivered signals as voice signals.

Also, DCN transmission signals and PCS transmission signals pass through the DCN duplexer 12 and the PCS duplexer 13, pass through the diplexer 11, and are transmitted via the antenna.

However, the PCS/DCN transceiver 10 of the dual band mobile communication terminal according to the related art uses a diplexer or an SPDT in order to separate dual signals. Realizing it in a single front end module (FEM) is dividing a filter function and an impedance matching function, which limits miniaturization of a module size.

Therefore, it is required to design a small-sized module that can perform all of a filter function, an impedance matching function, and a noise component suppression function, and can be mounted in a mobile communication terminal that is gradually miniaturized when realizing a multi-band transceiver such as the dual band transceiver in a single module.

### SUMMARY OF THE INVENTION

Accordingly, the present invention is related to a signal processing apparatus that substantially obviates one or more problems due to limitations and disadvantages of the related art.

The present invention provides a signal processing apparatus for accurately separating signals output and input via a single antenna into signals in at least two frequency bands.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

The embodiment of the invention provides a signal processing apparatus comprising: a first signal separating unit for receiving first reception signals via an antenna, allowing first transmission signals to be transmitted via the antenna, and blocking second reception signals; and a second signal separating unit for receiving the second reception signals via the antenna, allowing second transmission signals to be transmitted via the antenna, and blocking the first reception signals.

The embodiment of the present invention provides a signal processing apparatus comprising: a first duplexer for receiving first reception signals via an antenna, and allowing first transmission signals to be transmitted via the antenna; a first signal processor for processing signals transmitted/received via the first duplexer; a second duplexer for receiving second reception signals via the antenna and allowing second transmission signals to be transmitted via the antenna; a second signal processor for processing signals transmitted/received via the second duplexer; a first phase shifter located at a front end of the first duplexer, and controlling impedance of the first duplexer to block the second reception signals; and a second phase shifter located at a front end of the second duplexer, and controlling impedance of the second duplexer to block the first reception signals.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic block diagram illustrating elements of a dual band mobile communication terminal according to a related art;

FIG. 2 is a schematic block diagram illustrating elements of a signal processing apparatus according to an embodiment of the present invention;

FIGS. 3 and 4 are exemplary circuit diagrams illustrating elements of a phase shifter provided to a signal processing apparatus according to an embodiment of the present invention;

FIG. 5 is a Smith chart illustrating input impedance characteristics of a DCN duplexer provided to a signal processing apparatus according to an embodiment of the present invention; and

FIG. 6 is an experiment graph illustrating a characteristic curve of transmission coefficient in a signal processing apparatus according to an embodiment of the present invention.

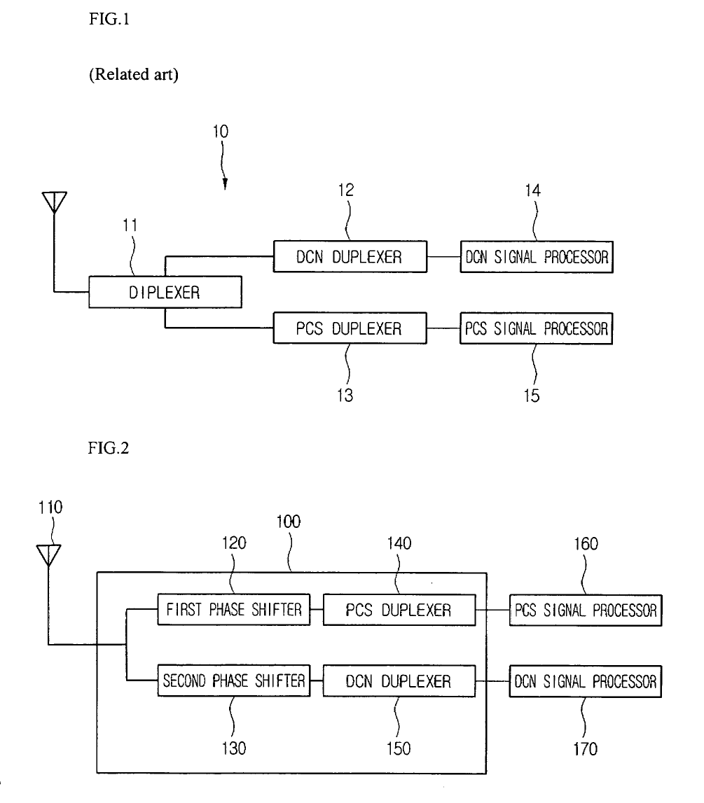

### DETAILED DESCRIPTION OF THE INVENTION

Reference will now be made in detail to the preferred embodiments of the present invention, examples of which are illustrated in the accompanying drawings.

FIG. 2 is a schematic block diagram illustrating elements of a signal processing apparatus according to an embodiment of the present invention.

Referring to FIG. 2, the signal processing apparatus 100 includes a first phase shifter 120, a second phase shifter 130, a PCS duplexer 140, and a DCN duplexer 150.

The first and second phase shifters 120 and 130 are connected to an antenna 110 at their input terminal, and connected to the PCS duplexer 140 and the DCN duplexer 150, respectively, at their output terminal.

The output terminals of the PCS duplexer 140 and the DCN duplexer 150 are connected to a PCS signal processor 160 and a DCN signal processor 170, respectively.

Here, the PCS duplexer 140 can include a transmission filter and a reception filter. The PCS signal processor 160 can include a reception processing part and a transmission processing part.

Therefore, reception signals in a PCS frequency band received via the antenna 110 are received to the reception processing part of the PCS signal processor 160 by way of the reception filter of the PCS duplexer 140. On the other hand, transmission signals in the PCS frequency band provided from the transmission processing part of the PCS signal processor 160 are output to the antenna 110 by way of the transmission filter of the PCS duplexer 140.

Also, the DCN duplexer 150 can include a transmission filter and a reception filter. The DCN signal processor 170 can include a reception processing part and a transmission processing part.

Therefore, reception signals in a DCN frequency band received via the antenna 110 are received to the reception processing part of the DCN signal processor 170 by way of the reception filter of the DCN duplexer 150. On the other hand, transmission signals in the DCN frequency band provided from the transmission processing part of the DCN signal processor 170 are output to the antenna 110 by way of the transmission filter of the DCN duplexer 150.

Meanwhile, though not shown, the signal processing apparatus 100 can be coupled to a GPS receiver. In the case where the GPS receiver is additionally provided for processing GPS signals, the GPS receiver includes a GPS receiving antenna, a GPS SAW filter, a GPS LNA, and a GPS signal processor.

The antenna 110 is a dual band antenna and receives signals in two different frequency bands such as a CDMA frequency band of 824-894 MHz and a PCS frequency band of 1.85-1.99 GHz.

Each of the first phase shifter 120 and the second phase shifter 130 includes a capacitor and an inductor to control an opening point of the duplexer so that the duplexer blocks signals of signals received via the antenna 110 that is not to be delivered.

That is, the first phase shifter 120 operates such that an opening point of the PCS duplexer 140 is controlled and an open circuit is formed to pass PCS signals and block DCN signals of PCS signals and DCN signals received via the antenna 110.

Also, the second phase shifter 130 operates such that an opening point of the DCN duplexer 150 is controlled and an open circuit is formed to pass DCN signals and lock PCS signals of PCS signals and DCN signals received via the antenna 110.

Therefore, PCS signals are delivered to the PCS duplexer 140, and DCN signals are delivered to the DCN duplexer 150.

The PCS duplexer 140 includes a high bandpass filter and a low bandpass filter including an integrated passive device (IPD). The high bandpass filter passes reception signals from the first phase shifter 120. The low bandpass filter passes transmission signals from the PCS signal processor 160.

That is, the PCS duplexer 140 allows delivered PCS signals to be delivered as transmission signals of 1.85-1.91 GHz, and reception signals of 1.93-1.99 GHz.

Therefore, transmission signals delivered from the PCS duplexer 140 are transmitted to the outside via the antenna 110, and reception signals are delivered to and reproduced at the PCS signal processor 160.

Also, the DCN duplexer 150 includes a high bandpass filter and a low bandpass filter including an IPD. The high bandpass filter passes reception signals from the second phase shifter 130. The low bandpass filter passes transmission signals from the PCS signal processor 170.

That is, the DCN duplexer 150 allows delivered DCN signals to be delivered as transmission signals of 824-849 MHz, and reception signals of 869-894 MHz.

Therefore, transmission signals delivered from the DCN duplexer 150 are transmitted to the outside via the antenna 110, and reception signals are delivered to and reproduced at the DCN signal processor 170.

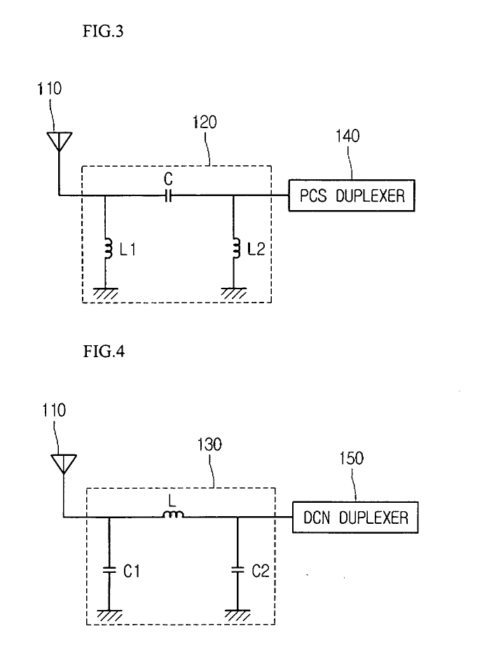

FIGS. 3 and 4 are exemplary circuit diagrams of a phase shifter provided to a signal processing apparatus according to an embodiment of the present invention.

FIG. 3 exemplarily illustrates the first phase shifter 120.

The first phase shifter 120 includes a capacitor C located between the antenna 110 and the PCS duplexer 140, a first inductor L1 having one end connected between the antenna 110 and the capacitor C, and the other end grounded, and a second inductor L2 having one end connected between the capacitor C and the PCS duplexer 140, and the other end grounded.

FIG. 4 exemplarily illustrates the second phase shifter 130.

The second phase shifter 130 includes an inductor L located between the antenna 110 and the DCN duplexer 150, a first capacitor C1 having one end connected between the antenna 110 and the inductor L, and the other end grounded, and a second capacitor C2 having one end connected between the inductor L and the DCN duplexer 150, and the other end grounded.

Meanwhile, the first phase shifter 120 and the second phase shifter 130 can have various circuit configurations depending on a characteristic of a terminal.

The first and second phase shifters 120 and 130 control impedance of the PCS duplexer 140 and the DCN duplexer 150 so that the first and second phase shifters 120 and 130 can operate as open circuits with respect to corresponding signals, respectively. At this point, inductance and capacitance of the inductor L and the capacitor C of the low pass type second phase shifter 130 are determined using Equation 1. Inductance and capacitance of the inductor L and the capacitor C of the high pass type first phase shifter 120 are determined using Equation 2.

$$\begin{matrix}\begin{matrix}C = \frac{{Y}_{0} tan ( \frac{β l}{2} )}{2 π {f}_{0}} , \\ L = \frac{{Z}_{0} sin ( β l )}{2 π {f}_{0}}\end{matrix} & Equation 1 \\ \begin{matrix}C = \frac{- 1}{2 π {f}_{0} {Z}_{0} sin ( β l )} , \\ L = \frac{- 1}{2 π {f}_{0} {Y}_{0} tan ( \frac{β l}{2} )} ,\end{matrix} & Equation 2\end{matrix}$$

where f₀ is a phase shift center frequency, π is the ratio of the circumference of a circle to its diameter, which is approximately 3.14, L is inductance, C is capacitance, Z₀ is characteristic impedance of a strip, which is 50Ω, Y₀=1/Z₀, and β1 is a phase shift of a phase shift center frequency.

For example, referring to FIG. 5, the DCN duplexer 150 should have controlled impedance to serve as an open circuit with respect to PCS signals in association with the second phase shifter 130. Accordingly, in the case where a phase shift of 108° is required at a PCS center frequency of 1880 MHz, inductance and capacitance can be “4 nH”, and “2.3 pF” according to Equation 1, respectively.

FIG. 5 is a Smith chart illustrating input impedance characteristics of a DCN duplexer provided to a signal processing apparatus according to an embodiment of the present invention.

Referring to FIG. 5, when a coordinate point of load impedance of an arbitrary signal is formed at a point A on a Smith chart, it means that a circuit of this point operates as an open circuit in an aspect of signals. On the other hand, when a coordinate point of load impedance of an arbitrary signal is formed at a point B on the Smith chart, it means that a circuit of this point operates as a short circuit in an aspect of signals.

Since the DCN duplexer 150 should operate as an open circuit with respect to PCS signals when input impedance of the DCN duplexer 150 is expressed at a point C on the Smith chart, the impedance should be matched to the point A on the Smith chart.

That is, since the second phase shifter 130 shifts a phase and matches the phase such that the DCN duplexer 150 serves as an open circuit with respect to PCS signals, the DCN duplexer 150 is high-impedance matched to serve as an open circuit with respect to PCS signals.

Likewise, the first phase shifter 120 is high-impedance matched such that the PCS duplexer 140 serves as an open circuit with respect to DCN signals.

As described above, signals received via the first and second phase shifters 120 and 130 can be delivered to the PCS signal processor 160 and the DCN signal processor 170 with almost no loss.

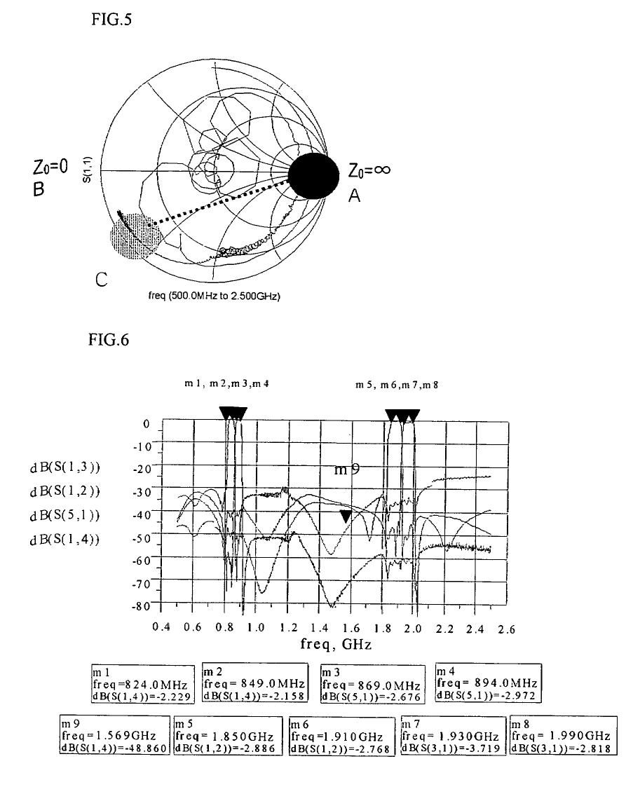

FIG. 6 is an experiment graph illustrating a characteristic curve of transmission coefficient in a signal processing apparatus according to an embodiment of the present invention.

Referring to FIG. 6, an S parameter means a power deliver ratio of an output port to an input port, where an x-axis is a frequency, a y-axis is a size of an S parameter expressed by a dB scale.

That is, S(1,2) is a ratio of an output of a terminal No. 1 to power input to a terminal No. 2. S(1,3) is a ratio of an output of the terminal No. 1 to power input to a terminal No. 3, meaning a reflection coefficient.

Numerical values dB(S(a,b)) shown in FIG. 6 are rates by which power is delivered from the antenna terminal to respective PCS/DCN terminals, or from the respective PCS/DCN terminals to the antenna terminal. For example, assuming that the antenna terminal is “a” and a PCS transmission terminal is “b”, the values dB(S(a,b)) are rates by which power is delivered from the PCS transmission terminal “b” to the antenna terminal “a”, that is, a deliver characteristic.

Referring to FIG. 2, assuming that the antenna terminal is referred to as 1, the PCS transmission terminal is referred to as 2, a PCS reception terminal is referred to as 3, a DCN transmission terminal is referred to as 4, and a DCN reception terminal is referred to as 5, m1 and m2 of FIG. 6 are delivery characteristics from the DCN transmission terminal 4 to the antenna terminal 1 with respect to a frequency of 824.0-849.0 MHz, and m3 and m4 are delivery characteristics from the antenna terminal 1 to the DCN reception terminal 5 with respect to a frequency of 869.0-894.0 MHz.

Also, m5 and m6 are delivery characteristics from the PCS transmission terminal 2 to the antenna terminal 1 with respect to a frequency of 1.85-1.91 GHz, and m7 and m8 are delivery characteristics from the antenna terminal 1 to the PCS reception terminal 3 with respect to a frequency of 1.93-1.99 GHz.

That is, when a rate of signals delivered between the antenna terminal 1 and respective transmission and reception terminals is 1 in transmission/reception frequency bands of PCS signals, i.e., DCN signals, values dB(S(a,b)) become “0”, which means that input signals are all delivered to the output port.

m9 means a characteristic that frequency signals in a frequency band of 1.57 GHz classified as noise signals are delivered from the DCN transmission terminal 4 to the antenna terminal 1.

Experiment graph of FIG. 6 shows that a signal loss (attenuation) in transmission/reception bands of DCN/PCS signals is in a range of (−)2.158−(−)3.719 dB, and noise attenuation is (−)48.86 dB. That is, a signal loss reduces and noise attenuation increases.

A signal processing apparatus according to the present invention has a branching characteristic of accurately separating signals in two different frequency bands, received via a single antenna, and can minimize a signal loss.

Also, a function of a diplexer can be performed by connecting a duplexer with a phase shifter.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A signal processing apparatus comprising:
a first signal separating unit for receiving first reception signals via an antenna, allowing first transmission signals to be transmitted via the antenna, and blocking second reception signals; and
a second signal separating unit for receiving the second reception signals via the antenna, allowing second transmission signals to be transmitted via the antenna, and blocking the first reception signals.

2. The apparatus according to claim 1, wherein the first signal separating unit comprises a first phase shifter and a first duplexer.

3. The apparatus according to claim 2, wherein the first phase shifter controls impedance of the first duplexer.

4. The apparatus according to claim 2, wherein the first phase shifter comprises: a capacitor connected to the first duplexer; and a first inductor and a second inductor parallel-connected at both ends of the capacitor.

5. The apparatus according to claim 2, wherein the first duplexer comprises an integrated passive device.

6. The apparatus according to claim 2, wherein the first duplexer comprises: a high bandpass filter for passing the first reception signals; and a low bandpass filter for passing the first transmission signals.

7. The apparatus according to claim 1, wherein the first reception signals are signals in a band of 1.93-1.99 GHz, and the first transmission signals are signals in a band of 1.85-1.91 GHz.

8. The apparatus according to claim 1, wherein the second signal separating unit comprises a second phase shifter and a second duplexer.

9. The apparatus according to claim 8, wherein the second phase shifter controls impedance of the second duplexer.

10. The apparatus according to claim 8, wherein the second phase shifter comprises: an inductor connected to the second duplexer; and a first capacitor and a second capacitor parallel-connected at both ends of the inductor.

11. The apparatus according to claim 8, wherein the second duplexer comprises an integrated passive device.

12. The apparatus according to claim 8, wherein the second duplexer comprises: a high bandpass filter for passing the second reception signals; and a low bandpass filter for passing the second transmission signals.

13. The apparatus according to claim 1, wherein the second reception signals are signals in a band of 869-894 MHz, and the second transmission signals are signals in a band of 824-849 MHz.

14. A signal processing apparatus comprising:
a first duplexer for receiving first reception signals via an antenna, and allowing first transmission signals to be transmitted via the antenna;
a first signal processor for processing signals transmitted/received via the first duplexer;
a second duplexer for receiving second reception signals via the antenna and allowing second transmission signals to be transmitted via the antenna;
a second signal processor for processing signals transmitted/received via the second duplexer;
a first phase shifter located at a front end of the first duplexer, and controlling impedance of the first duplexer to block the second reception signals; and
a second phase shifter located at a front end of the second duplexer, and controlling impedance of the second duplexer to block the first reception signals.

15. The apparatus according to claim 14, wherein the first phase shifter comprises: a capacitor located at a front end of the first duplexer; a first inductor having one end connected at a front end of the capacitor, and the other end grounded; and a second inductor having one end connected between the capacitor and the first duplexer, and the other end grounded.

16. The apparatus according to claim 14, wherein the first reception signals and the first transmission signals are personal communication service signals.

17. The apparatus according to claim 14, wherein the first reception signals are signals in a band of 1.93-1.99 GHz, and the first transmission signals are signals in a band of 1.85-1.91 GHz.

18. The apparatus according to claim 14, wherein the second phase shifter comprises: an inductor located at a front end of the second duplexer; a first capacitor having one end connected at a front end of the inductor, and the other end grounded; and a second capacitor having one end connected between the inductor and the second duplexer, and the other end grounded.

19. The apparatus according to claim 14, wherein the second reception signals and the second transmission signals are digital cellular network signals.

20. The apparatus according to claim 14, wherein the second reception signals are signals in a band of 869-894 MHz, and the second transmission signals are signals in a band of 824-849 MHz.
